(19) United States
(12) Patent Application Publication
(10) Pub. No.: US 2011/0264514 A1
(43) Pub. Date: Oct. 27, 2011

(54) BILLING METHOD AND SYSTEM THAT DETERMINES ADVERTISEMENT COSTS ACCORDING TO UNIT TIME

(75) Inventors: Ki Oh Kwon, Seongnam-si (KR); Yuwon Kim, Seongnam-si (KR); Won Sook Noh, Seongnam-si (KR); Woongsup Shin, Seongnam-si (KR); Woosung Lee, Seongnam-si (KR); Min Seon Jeon, Seongnam-si (KR); Seojin Han, Seongnam-si (KR); Ha Nyung Chung, Seongnam-si (KR)

(73) Assignee: NHN BUSINESS PLATFORM CORPORATION, Seongnam-si (KR)

(21) Appl. No.: 13/123,502

(22) PCT Filed: Oct. 9, 2009
(86) PCT No.: PCT/KR09/05793

§ 371 Date: Jun. 29, 2011

(30) Foreign Application Priority Data
Oct. 9, 2008 (KR) 10-2008-0099101

(51) Int. Cl. G06Q 30/00

(52) U.S. Cl. 705/14.45; 705/14.41

(57) ABSTRACT

A charging method and system for determining an advertising cost according to a unit time are provided. The charging method includes checking a performance index numerically indicating performance of an advertisement; checking a priority index of a next-priority advertisement to the advertisement; and determining an actual charge per unit time of the advertisement based on the performance index, the priority index, and a predetermined weight.

### TECHNICAL FIELD

The present invention relates to a charging method and system that determine an advertising cost according to a unit time, and more particularly, to a charging method and system capable of determining an advertising cost for an advertisement exposed according to a unit time.

### BACKGROUND ART

Internet advertising, that is, advertising through the medium of the Internet, enables enterprises to contact a great number of consumers at a low cost and immediately recognize reactions of customers through an advertisement using merits of the Internet. Among Internet advertising methods, keyword advertising refers to an advertising method that exposes an advertisement of a relevant enterprise on a screen as a search result upon input of a search term. For example, when a user inputs a search term related to ‘moving,’ advertisements related to ‘pack moving’, ‘moving center’, and the like may be exposed as a result of the search. Thus, since advertisements are exposed to those interested in particular goods or service, the advertising effect will be high.

An Internet advertisement is sold to an advertiser in various forms of advertisement products. An advertisement to be exposed, corresponding to an advertisement product sold by an auction, may be determined by a bid price input by a corresponding advertiser. For example, an advertisement of an advertiser who suggested a second high bid price may be exposed as having the highest bid price, through an uppermost position of an advertisement exposure region among advertisement exposure regions relate to the corresponding advertisement products. An advertisement providing method and system enabling efficient bidding will be described.

### DISCLOSURE OF INVENTION

### Technical Goals

An aspect of the present invention provides a charging method and system capable of determining an advertisement cost for an advertisement exposed according to a unit time, based on a performance index of the advertisement, a priority index of a next-priority advertisement to the advertisement, and a predetermined weight.

Another aspect of the present invention provides a charging method and system capable of determining an actual charge per unit time as a minimum amount for maintaining the priority of the advertisement during the unit time, using a minimum incremental unit as the performance index, the priority index, and the weight.

### Technical Solutions

According to an aspect of the present invention, there is provided a charging method including checking a performance index numerically indicating performance of an advertisement; checking a priority index of a next-priority advertisement to the advertisement; and determining an actual charge per unit time of the advertisement based on the performance index, the priority index, and a predetermined weight.

The priority index may be calculated based on a final bid price of an advertiser and the performance index.

The performance index may be calculated based on an actual number of clicks measured with respect to the advertisement during a predetermined time period and an expected number of clicks expected with respect to the advertisement during the predetermined time period.

The weight may include a minimum incremental unit, and the minimum incremental unit may include a minimum incremental value to be included in a current input bid price in addition to a previously input bid.

The actual charge per unit time may be equal to or less than a final bid price of an advertiser.

The checking of the priority index of the next-priority advertisement may include checking a priority index of an advertisement having a valid priority index among lower-priority advertisements, as the priority index of the next-priority advertisement, when the priority index of the next-priority advertisement is invalid.

According to an aspect of the present invention, there is provided a charging system including a performance index checking module to check a performance index numerically indicating performance of the advertisement; a priority index checking module to check a priority index of a next-priority advertisement to the advertisement; and an actual charge determining module to determine an actual charge per unit time of the advertisement based on the performance index, the priority index, and a predetermined weight.

### Effects

According to the embodiment of the present invention, an advertising cost for an advertisement exposed in units of unit time may be determined based on a performance index of the advertisement, a priority index of a next-priority advertisement to the advertisement, and a predetermined weight.

Also, an actual charge per unit time may be determined as a minimum amount for maintaining the priority of the advertisement during the unit time, using a minimum incremental unit as the performance index, the priority index, and the weight.

In addition, according to the embodiment of the present invention, since the advertising cost is calculated per advertisement exposure region based on a bid price per unit time, rather than being calculated according to a number of clicks of an advertisement. Therefore, problems caused by malicious clicks by a particular user or group may be fundamentally prevented.

### BRIEF DESCRIPTION OF DRAWINGS

FIG. 1 illustrates a diagram showing a part of a search result page corresponding to a keyword input by a user;

FIG. 2 illustrates a flowchart describing a charging method according to an embodiment of the present invention;

FIG. 3 illustrates a diagram showing an example table containing information necessary for measuring an actual charge;

FIG. 4 illustrates a diagram describing a bid price per unit time; and

FIG. 5 illustrates a block diagram describing an inner structure of a charging system according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

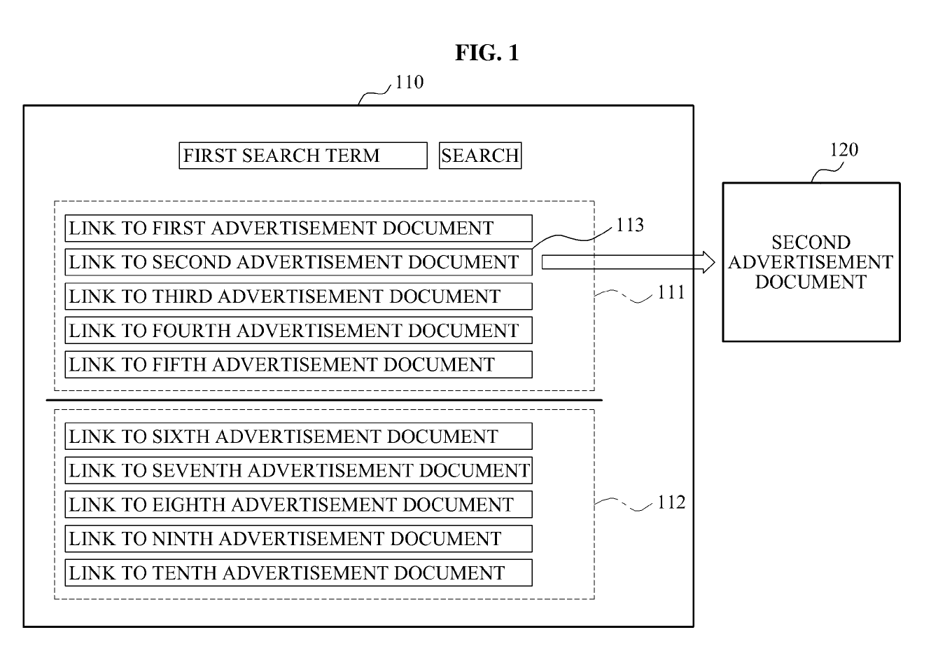

FIG. 1 illustrates a diagram showing a part of a search result page 110 corresponding to a keyword input by a user. The search result page 110 shows a search result regarding a first search term input by a user. In the search result 110, links to advertisement documents may be set per an advertisement product as shown by two dotted-line boxes 111 and 112 in the drawing. Specifically, the search result page 110 according to the embodiment shows five links each set for two advertisement products. Here, when a click event occurs with respect to a link 113 to a second advertisement document 120, the second advertisement document 120 may be provided to the user. Such links to the advertisement documents may be allocated to a sold region when a corresponding advertisement product is purchased according to the keyword such as the first search term. Sale of an advertisement exposure region set with the links may be performed through an auction.

A charging system according to an embodiment of the present invention may determine an advertising cost of an advertisement exposed through the advertisement exposure region. Specifically, the charging system may determine the advertising cost by determining an actual charge per unit time as a minimum amount for maintaining a priority of the advertisement during the unit time, using a minimum incremental unit as a performance index, a priority index, and a predetermined weight.

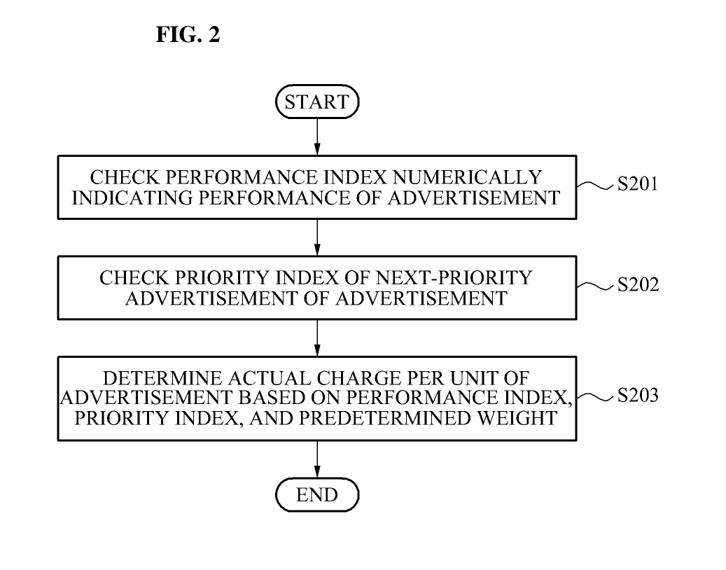

FIG. 2 illustrates a flowchart describing a charging method according to an embodiment of the present invention. The charging method according to the embodiment of the present invention may be performed by the charging system of FIG. 1. The advertisement providing method will be described mainly in regard to respective operations performed by the advertisement providing system, with reference to the FIG. 2.

In operation S201, the charging system checks the performance index, that is, a numerical index of performance of an advertisement. The performance index may be calculated based on an actual number of clicks measured with respect to the advertisement during a predetermined time period and an expected number of clicks with respect to the advertisement during the predetermined time period. For example, the performance index may be calculated based on a ratio between the expected number of clicks and the actual number of clicks. The expected number of clicks may be calculated based on a number of clicks per advertisement exposure region, the clicks generated while the advertisement is being exposed through at least one of advertisement exposure regions included in the search result page, and also based on at least one of predetermined region weights with respect to the respective advertisement exposure regions. For example, when the advertisement is exposed through one advertisement exposure region for 10 days, that is, from July 13 to July 22, and when the predetermined time period is 10 days, that is, from August 10 to August 19, the expected number of clicks with respect to the predetermined time period may be calculated based on the number of clicks during the exposure of the advertisement for 10 days from July 13 to July 22 and based on the region weight with respect to the one advertisement exposure region. In the case where the advertisement has been previously exposed, through at least two of the advertisement exposure regions, the expected number of clicks may be calculated based on the number of clicks measured per advertisement exposure region and the region weight of the corresponding advertisement exposure region. The region weight may be determined by the charging system or the operator of the charging system according to a predetermined plan. The region weight may be applied to the number of clicks per advertisement exposure region, through addition or multiplication. The expected number of clicks and the actual number of clicks may be calculated or measured by the charging system or by another system in association with the charging system.

In operation S202, the charging system checks the priority index of a next-priority advertisement to the advertisement. The priority index may be calculated based on a final bid price of the advertiser and the performance index, to be used in determining success or failure of the bid and an exposure priority of a corresponding advertisement. In other words, success of the bid of the advertisement and the exposure priority may be determined not simply by the final bid price input by the advertiser but in consideration of both the final bid price and the performance index indicating the performance of the advertisement.

When the priority index of the next-priority advertisement is no longer valid, the charging system may check a priority index of an advertisement having a valid priority index among advertisements of lower priorities, as the priority index of the next-priority advertisement. For example, when priority index of a fourth-priority advertisement, that is, the next-priority advertisement to a third-priority advertisement, is invalid, the charging system may check and use a priority index of a fifth-priority advertisement. Here, the priority index may be invalid when the advertisement does not satisfy a predetermined standard such as quality of the advertisement.

In operation S203, the charging system determines the actual charge per unit time based on the performance index, the priority index, and the predetermined weight. Here, the weight may include the minimum incremental unit which may include a minimum value of increment to be included in a current input bid price in addition to a previously input bid. The minimum incremental unit may be calculated based on an initial bid price, an input bid price, and a maximum bid price during an auction. The minimum incremental unit may be used to force the advertiser to input a higher bid price than a previous bid price by at least the minimum incremental unit. In the present embodiment, the minimum incremental unit may be used to adjust a gap generated by use of the priority index of the next-priority advertisement instead of the priority index of the advertisement.

According to an embodiment of the present invention, the minimum incremental unit may be set as desired by an operator of an advertisement providing system. The minimum incremental unit may be used as a factor for adjusting an actual cost of the advertiser to be slightly higher than a bid price of a next-priority advertiser. The minimum incremental unit may be determined based on a monetary unit of the bid price of the advertiser. For example, presuming that the minimum incremental unit is set to 1/100 of a monetary unit of the bid price of the advertiser, when the bid price of the advertiser is in units of 100 thousand won, the minimum incremental unit becomes one thousand won. When the bid price of the advertiser is in units of 10 thousand won, the minimum incremental unit becomes 100 won. This will be more easily understood with reference to Table 1 as shown below.

TABLE 1

| Exposure | | |
|---|---|---|
| priority | Bid price | Actual cost |
| First | 101,000 won | 101,000 won + 1,000 won |
| Second | 10,100 won | 9,010 won + 100 won |
| Third | 9,010 won | Bid price of next-priority advertiser + |
| | | minimum incremental unit |

Hereinafter, an exemplary method for bidding a keyword of the advertiser will be described in detail. In the following description, specific dates, days, and hours are suggested only by way of example. Therefore, various other dates, days, and hours or their altered forms may be used.

\textcircled{1} Regular Bidding

For example, the regular bidding may be closed at 3 p.m. every Wednesday and an advertisement may be exposed for 7 days from midnight the next day, that is, on Thursday. The advertiser may be notified of a result of successful bidding by e-mail or a mobile phone message. Since, regular bidding starts anew right after the previous regular bidding of Wednesday at 3 p.m., the advertiser may participate in the next regular bidding even though the advertiser previously failed to make a successful bid.

\textcircled{2} Irregular Bidding

The irregular bidding, that is, additional bidding may be performed everyday for remaining publication days (7-DAY) with respect to passed or cancelled keywords for bidding. When any keyword needs to be exposed even for a short time, the advertiser may expose the corresponding advertisement through the irregular bidding even after the regular bidding is closed. Information on a number or type of the passed or cancelled keywords may be supplied through a dedicated management page, thereby enabling the advertiser to participate in the irregular bidding.

\textcircled{3} Automatic Bidding

The automatic bidding enables the advertiser to more conveniently manage the advertising, the advertiser who wants keyword advertising at a minimum management cost. The advertiser who uses the automatic bidding may manage advertising according to advertisement groups. In addition, the advertiser may automatically participate in the regular bidding without having to check a bidding state every time, through an on/off bidding function and an additional bidding participation option. When using the additional bidding participation option, the advertiser may be able to automatically participate in the irregular bidding occurring due to various reasons.

The initial bid price may be determined according to a bid object keyword to be bid by the advertiser. For example, the initial bid price with respect to a unit time (duration for exposure of an advertisement) of the bid object keyword may be determined using data related to a number of searches for the bid object keyword and a number of clicks of the advertisement using the bid object keyword. In this case, an advertising cost and an advertisement exposure priority with respect to one advertisement document during the unit time may be fixed. Also, the initial bid price with respect to a unit time of the bid object keyword may be determined based on advertisement history information of the bid object keyword. The advertisement history information may include at least one of all types of measurable information related to the bid object keyword, such as a number of clicks, a cost per click (CPC), a number of hits, a number of exposures, and a number of purchases. For example, an average CPC of the bid object keyword and an average number of clicks corresponding to the unit time for exposure of the advertisement may be used as the advertisement history information. When bidding of a keyword for exposing an advertisement for ‘7 days’ is performed, the initial bid price for the bid object keyword may be determined as “average CPC X estimated averaged number of clicks for 7 days.”

In addition, the actual charge per unit time may be equal to or less than the final bid price of the advertiser. In other words, the charging system may adjust the actual charge per unit time not to exceed the final bid price which is the bid price input with respect to the unit time by the advertiser. For example, when the actual charge per unit time is equal to or greater than the final bid price, the charging system may eventually determine the final bid price as the actual charge per unit time.

Also, when the advertisement is a last-priority advertisement, the charging system may determine an initial bid price for a corresponding keyword or a bid price of the corresponding advertiser, as the actual charge per unit time of the advertisement. That is, since the last-priority advertisement cannot use the priority index of the next-priority advertisement, the initial bid price or the final bid price of the corresponding advertiser input based on the initial bid price may be used directly.

Herein, the term ‘unit time’ refers to a duration from a certain time to another certain time. The certain time with respect to a random keyword and the advertisement exposure region (or a field on a webpage) according to the random keyword may be determined as necessary by the advertisement providing system, the operator of the advertisement providing system, or the advertiser. For example, the advertisement providing system may divide one day into 144 unit times of a 10-minute interval, with respect to the keyword and the advertisement exposure region. After the actual charge per unit time is determined as described in the foregoing, the advertising cost generated by exposure of the advertisement may be determined. That is, when the actual charge per unit time determined with respect to the advertisement is “2,000 won” and the advertisement is exposed for “5 unit times,” the advertising cost may be calculated to “10,000 won.” Since the weight may be applied to the actual charge per unit time according to conditions such as time zones, days, and consecutive holidays, the actual charge per unit time may be different according to the unit time. In this case, the advertising cost and the advertisement exposure priority with respect to one advertisement document may be fixed for one unit time.

According to an embodiment of the present invention, in bidding for an advertisement document, the initial bid price with respect to the bid object keyword may be determined so that the advertisers perform keyword bidding, and the advertisement may be provided to the advertisers ranked in a descending order of bid prices. For example, the advertisements may be provided to the advertisers of a first priority to a fifth priority through five advertisement exposure regions. While the priority of the advertisers is determined in the descending order of the bid price, the actual cost paid by an advertiser may be determined based on a bid price of a next-priority advertiser. In this case, the actual cost paid by the advertiser may be set equal to the bid price of the next-priority advertiser. However, the actual cost may be determined as an amount calculated by adding the bid price of the next-priority advertiser to the minimum incremental unit. That is, it may be satisfied by the following “actual cost=bid price of next-priority advertiser+minimum incremental unit.”

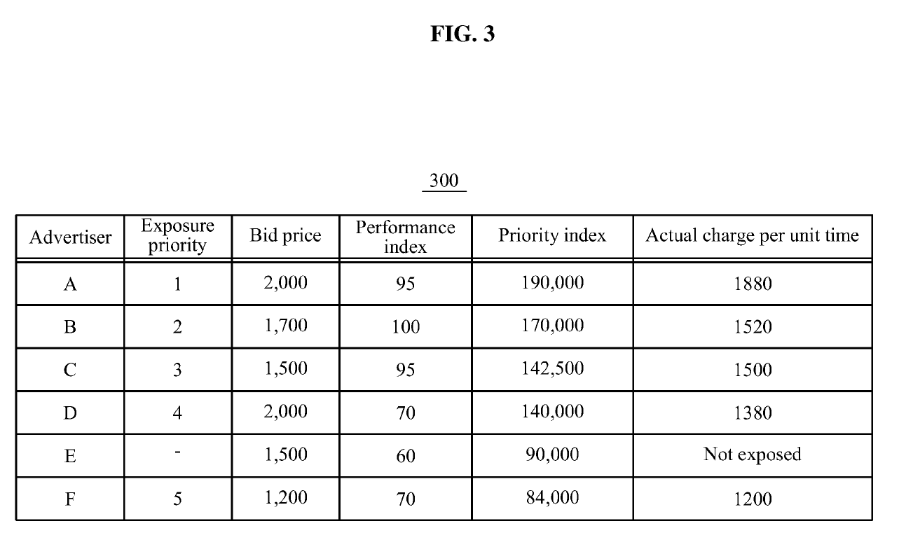

FIG. 3 illustrates a diagram showing table 300 containing example information necessary for measuring an actual charge. Table 300 shows the actual charge per unit time with respect to 6 advertisers who suggested their bid prices for one keyword. Here, the bid prices refer to final bid prices of the advertisers. The priority indexes shown in table 300 are calculated by multiplication of the bid prices and the performance indexes. The actual charges per unit time shown in table 300 may be calculated by Equation 1 below.

$${CPT}_{i} = Min \{ floor ( \frac{{RI}_{i + 1}}{{PI}_{i} \times 10} ) \times 10 + MIU , {BA}_{i} \} \qquad [ Equation 1 ]$$

wherein, ‘CPTᵢ’ denotes the actual charge per unit time with respect to an advertisement having an i-th exposure priority, ‘Min(a,b)’ denotes a function that provides a smaller value between ‘a’ and ‘b’ as a result value, ‘floor( )’ denotes a function that removes a number in a ones position from a value in the parentheses, ‘ RIᵢ’denotes a priority index of the advertisement having the i-th exposure priority, ‘PIᵢ’denotes a performance index of the advertisement having the i-th exposure priority, ‘MIU’ denotes the minimum incremental unit, and ‘BAᵢ’ denotes a bid price of the advertisement having the i-th exposure priority. As an example, in table 300, the actual charge per unit time of the advertiser ‘C’ is calculated by Equation 2 and the actual charge per unit time of the advertiser ‘D’ is calculated by Equation 3. Equations 2 and 3 are introduced below. Here, ‘100’ is applied as the minimum incremental is unit.

$$\begin{matrix}{CPT}_{i} = Min \{ floor ( \frac{140000}{95 \times 10} ) \times 10 + 100 , 1500 \} = 1500 & [ Equation 2 ] \\ {CPT}_{i} = Min \{ floor ( \frac{84000}{70 \times 10} ) \times 10 + 100 , 2000 \} = 1300 & [ Equation 3 ]\end{matrix}$$

Here, Equation 3 expresses a case of using a priority index of an advertiser ‘F’ in calculating the actual charge per unit time because a priority index of an advertiser ‘E’ is invalid, the advertiser ‘E’ who is the advertiser of the next-priority advertisement of an advertisement of the advertiser ‘D.’

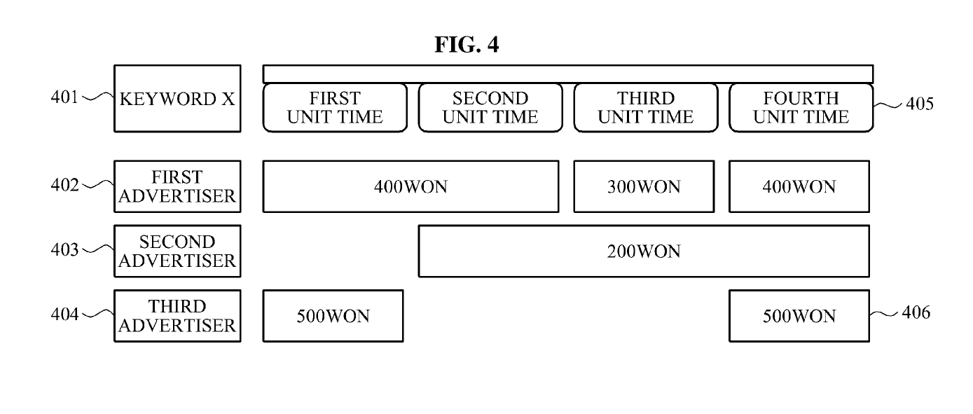

FIG. 4 illustrates a diagram describing a bid price per unit time. As described above, the bid price per unit time refers to a bid price with respect to the unit time rather than to the number of clicks. That is, FIG. 4 shows an example of the bid price per unit time input by a first advertiser 402, a second advertiser 403, and a third advertiser 404 with respect to the unit time for a keyword X 401. As shown in FIG. 4, the first advertiser 402 suggested 400 won for a first unit time and a second unit time, 300 won for a third unit time, and 400 won for a fourth unit time 405. Presuming that sale is performed simply by the bid price per unit time with respect to the corresponding unit time, an advertisement of the third advertiser 404, who suggested ‘500 won’ as a highest bid price 406 per unit time with respect to the fourth unit time 405, may be exposed through the corresponding advertisement exposure region with respect to the keyword X 401 during the fourth unit time 405. As aforementioned, according to the embodiments of the present invention, the advertising cost is calculated per unit time based on the bid price per unit time corresponding to the keyword and the advertisement exposure region, rather than being calculated according to the number of clicks of the link to the advertisement document. Therefore, problems caused by malicious clicks by a particular user or group may be fundamentally prevented.

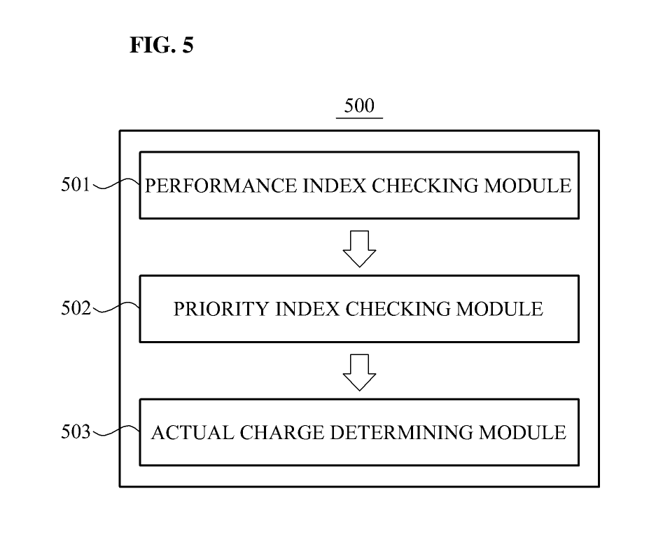

FIG. 5 illustrates a block diagram describing an inner structure of a charging system 500 according to an embodiment of the present invention. As shown in FIG. 5, the charging system 500 may include a performance index checking module 501, a priority index checking module 502, and an actual charge determining unit 503.

The performance index checking module 501 may check the performance index numerically indicating performance of the advertisement. The performance index may be calculated based on the actual number of clicks measured with respect to the advertisement during a predetermined time period, and based on the expected number of clicks expected with respect to the advertisement during the predetermined time period. For example, the performance index may be calculated based on a ratio between the expected number of clicks and the actual number of clicks. In addition, the expected number of clicks may be calculated based on the number of clicks per advertisement exposure region, the clicks generated while the advertisement is being exposed through at least one of advertisement exposure regions included in the search result page, and also based on at least one of the predetermined region weights with respect to the respective advertisement exposure regions. For example, when the advertisement is exposed through one advertisement exposure region for 10 days, that is, from July 13 to July 22, and when the predetermined time period is 10 days, that is, from August 10 to August 19, the expected number of clicks with respect to the predetermined time period may be calculated based on the number of clicks during the exposure of the advertisement for 10 days from July 13 to July 22 and based on the region weight with respect to the one advertisement exposure region. In the case where the advertisement has been previously exposed through at least two of the advertisement exposure regions, the expected number of clicks may be calculated based on the number of clicks measured per advertisement exposure region and the region weight of the corresponding advertisement exposure region. The region weight may be determined by the charging system 500 or the operator of the charging system 500 according to a predetermined plan. The region weight may be applied to the number of clicks per advertisement exposure region, through addition or multiplication. The expected number of clicks and the actual number of clicks may be calculated or measured by the charging system 500 or by another system (not shown) in association with the charging system.

The priority index checking module 502 may check the priority index with respect to the next-priority advertisement to the advertisement. The priority index may be calculated based on the final bid price of the advertiser and the performance index, to be used in determining success or failure of the bid and the exposure priority of the corresponding advertisement. In other words, whether the bid of the advertisement is successful and the exposure priority may be determined not simply by the final bid price input by the advertiser but by considering both the final bid price and the performance index indicating the performance of the advertisement.

When the priority index of the next-priority advertisement is invalid, the priority index checking module 502 may check the priority index of the advertisement having the valid priority index among advertisements of lower priorities, as the priority index of the next-priority advertisement. For example, when priority index of the fourth-priority advertisement, that is, the next-priority advertisement to the third-priority advertisement, is invalid, the priority index checking module 502 may check and use the priority index of the fifth-priority advertisement. Here, the priority index may be invalid when the advertisement does not satisfy a predetermined standard such as quality of the advertisement.

The actual charge determining module 503 determines the actual charge per unit time based on the performance index, the priority index, and the predetermined weight. Here, the weight may include the minimum incremental unit. The minimum incremental unit may include the minimum value of increment to be included in the current input bid price in addition to the previously input bid. The minimum incremental unit may be calculated based on the initial bid price, the input bid price, and the maximum bid price during the auction. The minimum incremental unit may be used to force the advertiser to input a higher bid price than a previous bid price by at least the minimum incremental unit. In the present embodiment, the minimum incremental unit may be used to adjust a gap generated by use of the priority index of the next-priority advertisement instead of the priority index of the advertisement.

The actual charge per unit time may be less than or equal to the final bid price of the advertiser. In other words, the actual charge determining module 503 may adjust the actual charge per unit time not to exceed the final bid price which is the bid price input with respect to the unit time by the advertiser. For example, when the actual charge per unit time is greater than or equal to the final bid price, the final bid price may be eventually determined as the actual charge per unit time.

In addition, when the advertisement is the last-priority advertisement, the actual charge determining module 503 may determine an initial bid price for a corresponding keyword or a bid price of the corresponding advertiser, as the actual charge per unit time of the advertisement. That is, since the last-priority advertisement cannot use the priority index of the next-priority advertisement, the initial bid price or the final bid price of the corresponding advertiser input based on the initial bid price may be directly used.

When the actual charge per unit time is determined as described above, the advertising cost generated by exposure of the advertisement may be determined. That is, when the actual charge per unit time determined with respect to the advertisement is “2,000 won” and the advertisement is exposed for “5 unit times,” the advertising cost may be calculated to be “10,000 won.” Since the weight may be applied to the actual charge per unit time according to conditions such as time zones, days, and consecutive holidays, the actual charge per unit time may be different according to the unit time.

The charging method or system according to the embodiment of the present invention may determine the advertising cost of the advertisement exposed according to the unit time based on the performance index of the advertisement, the priority index of the next-priority advertisement to the advertisement, and the predetermined weight. Also, the charging method or system may be capable of determining the actual charge per unit time as the minimum amount for maintaining the priority of the advertisement during the unit time, using the minimum incremental unit as the performance index, the priority index, and the weight. In addition, since the advertising cost is calculated per advertisement exposure region based on the bid price per unit time, rather than being calculated according to the number of clicks of an advertisement. Therefore, problems caused by malicious clicks by a particular user or group may be fundamentally prevented.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method comprising:
calculating a performance index numerically indicating performance of an advertisement;
calculating a priority index of a next-priority advertisement to the advertisement; and
determining an actual charge per unit time of the advertisement based on the calculated performance index and the priority index associated with a weight.

2. The charging method of claim 1, wherein the priority index is calculated based on a final bid price of an advertiser and the performance index.

3. The charging method of claim 1, wherein the performance index is calculated based on an actual number of clicks measured with respect to the advertisement during a time period and an expected number of clicks with respect to the advertisement during the time period.

4. The charging method of claim 3, wherein the expected number of clicks are calculated based on a number of clicks per advertisement, the clicks generated while the advertisement being exposed through at least one of advertisement exposure regions contained in the search result page, and also based on at least one of predetermined region weights with respect to the respective advertisement exposure regions.

5. The charging method of claim 1, wherein
the weight comprises a minimum incremental unit, and
the minimum incremental unit comprises a minimum value of increment to be included in a current input bid price in addition to a previously input bid.

6. The charging method of claim 5, wherein the minimum incremental unit is calculated based on an initial bid price, an input bid price, and a maximum bid price during an auction.

7. The charging method of claim 1, wherein the actual charge per unit time is less than or equal to a final bid price of an advertiser.

8. The charging method of claim 1, wherein the calculating of the priority index of the next-priority advertisement comprises:
calculating a priority index of an advertisement having a valid priority index among lower-priority advertisements as the priority index of the next-priority advertisement, in response to a detection of an invalid priority index of the next-priority advertisement.

9. The charging method of claim 1, wherein the determining an actual charge per unit time comprises:
determining an initial bid price for a corresponding keyword as the actual charge per unit time of the advertisement if the advertisement is detected as a last-priority advertisement.

10. The charging method of claim 1, wherein the determining an actual charge per unit time comprises:
determining a final bid price of a corresponding advertiser as the actual charge per unit time of the advertisement if the advertisement is detected as a last-priority advertisement.

11. A non-transitory computer readable recording medium comprising a computer executable program, which when executed by a processor of the computer, instructs the processor to the method of claim 1.

12. A system comprising:
a performance index checking module configured to calculate a performance index numerically indicating performance of an advertisement;
a priority index checking module configured to calculate a priority index of a next-priority advertisement to the advertisement; and
an actual charge determining module configured to determine an actual charge per unit time of the advertisement based on the calculated performance index and the priority index associated with a weight.

13. The charging system of claim 12, wherein the priority index is calculated based on a final bid price of an advertiser and the performance index.

14. The charging system of claim 12, wherein the performance index is calculated based on an actual number of clicks measured with respect to the advertisement during a predetermined time period and an expected number of clicks with respect to the advertisement during the time period.

15. The charging system of claim 12, wherein
the weight comprises a minimum incremental unit, and
the minimum incremental unit comprises a minimum value of increment to be included in a current input bid price in addition to a previously input bid.

16. The charging system of claim 12, wherein the priority index checking module is configured to check a priority index of an advertisement having a valid priority index among lower-priority advertisements as the priority index of the next-priority advertisement, in response to a detection of an invalid priority index of the next-priority advertisement.
